(19) United States
(12) Patent Application Publication
(10) Pub. No.: US 2004/0121802 A1
(43) Pub. Date: Jun. 24, 2004

(54) Hybrid mobile terminal and method for automatically powering on/off mobile phone

(75) Inventors: Jin-Tae Kim, Suwon-shi (KR); Jeong-Ho Kim, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/651,385

(22) Filed: Aug. 28, 2003

(30) Foreign Application Priority Data
Dec. 24, 2002 (KR) P2002-83411

(51) Int. Cl. H04M 1/00

(52) U.S. Cl. 455/556.2; 455/556.1

(57) ABSTRACT

A hybrid mobile terminal for performing a PDA (Personal Digital Assistant) function and a mobile phone function. The hybrid mobile terminal includes a PDA function module for controlling the PDA function, generating a GPIO (General Purpose Input Output) signal for initiating a mobile phone function on the basis of a prescribed condition for initiating the mobile phone function, and generating a termination command for terminating the mobile phone function on the basis of a prescribed condition for terminating the mobile phone function; and a mobile phone function module for controlling the mobile phone function after being activated upon receiving one of the GPIO signal received from the PDA function module and a power key entry signal of the hybrid mobile terminal.

### PRIORITY

This application claims priority to an application entitled “HYBRID MOBILE TERMINAL AND METHOD FOR AUTOMATICALLY POWERING ON/OFF MOBILE PHONE”, filed in the Korean Intellectual Property Office on Dec. 24, 2002 and assigned Serial No. 2002-83411, the contents of which are hereby incorporated by reference herein.

### BACKGROUND OF THE INVENTION

1. Field of the Invention

The present invention relates to a hybrid mobile terminal, and more particularly to a hybrid mobile terminal and method for automatically powering on/off a mobile phone.

2. Description of the Related Art

Typically, a hybrid mobile terminal called a Smart phone has been comprised of a mobile phone section for executing a communication function and a PDA (Personal Digital Assistant) section for executing a computing function.

FIG. 1 is a view illustrating a block diagram of a conventional hybrid mobile terminal.

Referring to FIG. 1, a conventional hybrid mobile terminal includes a display controller 10 for displaying a variety of operation states, a PDA module 20 for executing a common PDA function, a mobile phone function module 30 for executing a wireless communication function, and a power-supply module 40 for providing a power-supply voltage to each of the above modules 10, 20 and 30, and an IPC task 50 for connecting the PDA module 20 and the mobile phone function module 30. For the convenience of description, a key entry unit, a speaker, and a microphone commonly contained in a general mobile terminal are not shown in FIG. 1. Such a conventional hybrid mobile terminal performs both a PDA function and a mobile phone function using a single mobile terminal such that it provides users with a variety of services.

However, the above conventional hybrid mobile terminal has a disadvantage in that its own PDA function is suddenly interrupted when a user receives a phone call from another party even though the PDA function is in progress and/or already executed. For example, in the case where a user of the hybrid mobile terminal receives a phone call from another party while playing an online game using a PDA function, a message for indicating such a phone call reception state instead of the online game screen is displayed on a display of the hybrid mobile terminal. As a result, the user who plays the online game using the PDA function must unavoidably quit playing the game. In this case, if the user decides not to answer the phone call, then the hybrid mobile terminal again performs the PDA function. In cases of an online task such as an online game which may be greatly affected by a user's key handling on a moment-to-moment basis, such a playing interruption may result in an inconvenience and/or financial loss. Also, for example, if a PDA function is suddenly interrupted while a user executes an online financial transaction such as an online stock trading, the amount of financial loss may increase unpredictably.

### SUMMARY OF THE INVENTION

Therefore, the present invention has been made in view of the above problems, and it is an object of the present invention to provide a hybrid mobile terminal with a variety of application uses and a method for controlling the same.

It is another object of the present invention to provide a hybrid mobile terminal for preventing its own PDA function from being interrupted, and a method for controlling the same.

In accordance with one aspect of the present invention, the above and other objects can be accomplished by the provision of a hybrid mobile terminal for performing a PDA (Personal Digital Assistant) function and a mobile phone function, comprising: a PDA function module for controlling the PDA function, generating a GPIO (General Purpose Input Output) signal for initiating a mobile phone function on the basis of a prescribed condition for initiating the mobile phone function, and generating a termination command for terminating the mobile phone function on the basis of a prescribed condition for terminating the mobile phone function; and a mobile phone function module for controlling the mobile phone function after being activated upon receiving one of the GPIO signal received from the PDA function module and a power key entry signal of the hybrid mobile terminal.

In accordance with another aspect of the present invention, there is provided a method for powering on or off a mobile phone function module of a hybrid mobile terminal composed of a PDA (Personal Digital Assistant) function module and the mobile phone function module, comprising the steps of: a) generating a GPIO (General Purpose Input Output) signal for initiating a mobile phone function on the basis of a prescribed condition for initiating the mobile phone function; b) applying a power-supply voltage to the mobile phone function module upon receiving the GPIO signal, and initializing the mobile phone function module to start the mobile phone function; c) generating a termination command for terminating the mobile phone function on the basis of a prescribed condition for terminating the mobile phone function; and d) terminating the operation of the mobile phone function module in accordance with the termination command.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a block diagram of a conventional hybrid mobile terminal;

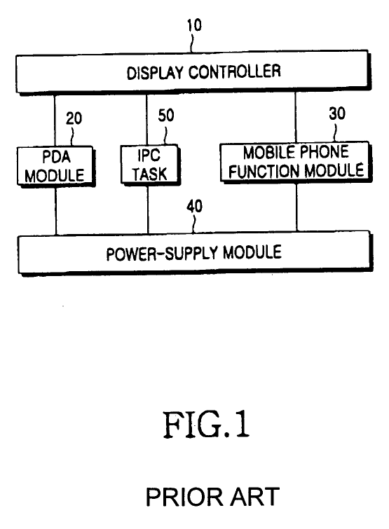

FIG. 2 is a view illustrating a schematic diagram of an apparatus for controlling a power-supply voltage of a mobile phone in a hybrid mobile terminal in accordance with a preferred embodiment of the present invention;

FIG. 3 is a flow chart illustrating a procedure for controlling a power-supply voltage of a mobile phone in a PDA function module contained in a hybrid mobile terminal in accordance with a preferred embodiment of the present invention; and

FIG. 4 is a flow chart illustrating a procedure for powering on/off a mobile phone in a mobile phone control module contained in a hybrid mobile terminal in accordance with a preferred embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it is well known in the art.

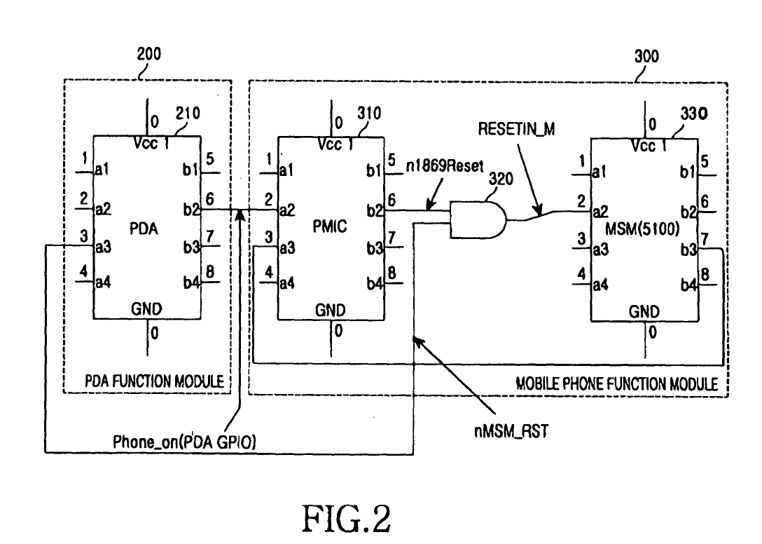

FIG. 2 is a view illustrating a schematic diagram of an apparatus for controlling a power-supply voltage of a mobile phone in a hybrid mobile terminal in accordance with a preferred embodiment of the present invention. Referring to FIG. 2, a hybrid mobile terminal according to the present invention includes a PDA function module 200 for controlling a PDA function, and a mobile phone function module 300 for controlling a mobile phone function.

The PDA function module 200 initiates or terminates the functioning of the mobile phone on the basis of prescribed conditions for initiating or terminating the mobile phone function. For this operation, the PDA function module 200 generates a GPIO (General Purpose Input Output) signal PDA_GPIO (“Phone_on” signal) for initiating the mobile phone function and a termination command for terminating the mobile phone function. The PDA function module 200 transmits the GPIO signal PDA_GPIO or the termination command to the mobile phone function module 300 when PDA functions or conditions make it desirable for the phone to be on or off, respectively. Typically, the PDA function module 200 and the mobile phone function module 300 of the hybrid mobile terminal execute data communication over an IPC (Inter Process Communication) task (not shown). Therefore, the termination command is transmitted from the PDA function module 200 to the mobile phone function module 300 over such an IPC task. However, such transmission of the termination command is possible only on the assumption that the PDA function module 200 and the mobile phone module 300 are all activated (i.e., the PDA function module 200 and the mobile phone module 300 are all powered on). For instance, such data communication over the IPC task is impossible when the mobile phone function module 300 is powered off.

Thus, the PDA function module 200 generates a predetermined GPIO signal to initiate a mobile phone function, and transmits it to the mobile phone function module 300.

In this case, preferably, a prescribed condition for initiating or terminating the mobile phone function is commonly indicated as a time value. For example, the PDA function module 200 compares an initiation time or a termination time of the mobile phone function being set up by a user with a current time. If the comparison indicates the current time is the same as the initiation time or the termination time of the mobile phone function, the PDA function module generates a GPIO signal for initiating the mobile phone function or a termination command for terminating the mobile phone function, and transmits the GPIO signal or the termination command to the mobile phone function module 300

The mobile phone function module 300 is activated by either one of the GPIO signal received from the PDA function module 200 and a power key entry signal of a hybrid mobile terminal, and then controls a mobile phone function of such a hybrid mobile terminal. In addition, the operation of the mobile phone function module 30 is terminated in accordance with the termination command transmitted by the PDA function module 200 via the IPC task or in response to the power key entry signal of the hybrid mobile terminal.

The mobile phone function module 300 includes a mobile phone function processor for executing mobile phone functions; a power-supply controller for applying a power-supply voltage to the mobile phone function processor upon receiving the GPIO signal, and for generating a reset signal for initiating the mobile phone function processor; and a logic gate for transmitting a reset signal to the mobile phone function processor on the basis of either one of the reset signal generated from the power-supply controller and a power key entry signal of the hybrid mobile terminal. As shown in FIG. 2, the mobile phone function processor is implemented with an MSM (Mobile Station Modem) 5100 chip 330, the power-supply controller is implemented with a PMIC (Power Management Integrated Circuit) chip 310, the PDA function module 200 is implemented with a PDA chip 210, and the logic gate is implemented with one AND gate 320.

The input terminal of the AND gate 320 receives a reset signal n1869Reset output by the PMIC 310 and a reset signal nMSM_RST generated by the PDA function module 200. The output terminal of the AND gate 320 is connected to the terminal of MSM (5100) 330, to which a reset signal RESETIN_M is inputted. Power is applied to the PDA function module 200 when the power key of the hybrid mobile terminal is pressed and the PDA function module 200 generates a reset signal nMSM_RST. If either the reset signal n1869Reset of PMIC 310 or the reset signal nMSM_RST of PDA function module 200 coincides with a reset condition of MSM (5100) 330, the AND gate 320 outputs a signal for resetting the MSM (5100) 330. For example, if either the reset signal n1869Rest or the reset signal nMSM_RST is “0’, the AND gate 320 outputs “0” to thereby reset the MSM (5100) 330.

The logic gate implemented with the AND gate may be implemented with another logic circuit for executing the above operations. For example, if the above-noted reset values are all “1”, then an OR gate may be used.

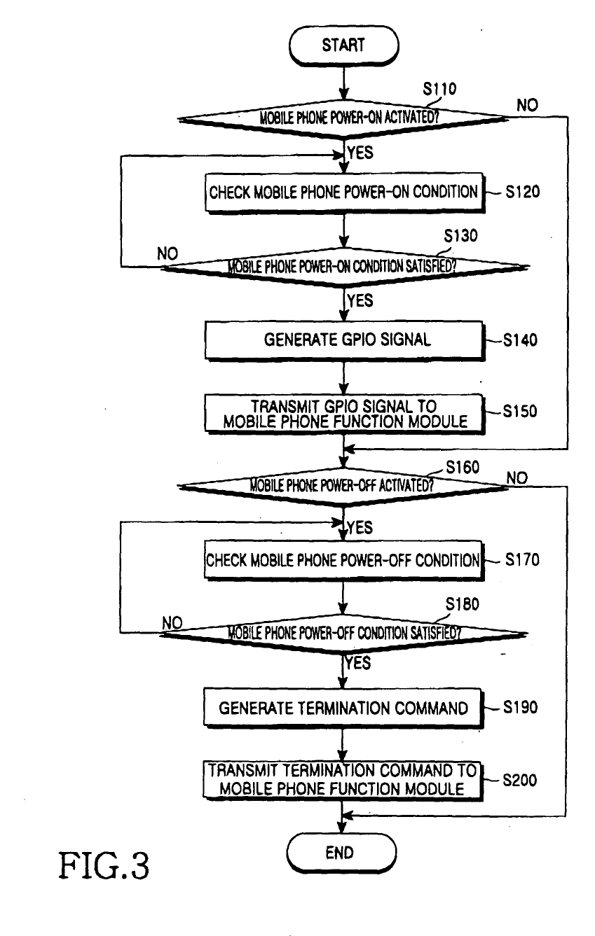

FIG. 3 is a flow chart illustrating a procedure for controlling a power-supply voltage of a mobile phone in a PDA function module contained in a hybrid mobile terminal in accordance with a preferred embodiment of the present invention. A method for controlling a power-supply voltage of a mobile phone in a PDA function module 200 of a hybrid mobile terminal in accordance with a preferred embodiment of the present invention will hereinafter be described with reference to FIGS. 2˜3.

Firstly, a PDA function module 200 determines at step S110 whether a PDA function for automatically powering on a mobile phone is activated. If it is determined at step S110 that the function for automatically powering on the mobile phone is activated, the PDA function module 200 checks a condition for powering on the mobile phone at step S120, and determines at step S130 whether the condition for powering on the mobile phone is satisfied. For instance, where a condition for powering on the mobile phone is indicated as time information, the PDA function module 200 checks a reserved date and time used for initiating a mobile phone function at step S120, and then compares a current time with the checked date and time at step S130.

If it is determined at step S130 that the condition for powering on the mobile phone is satisfied, the PDA function module 200 generates a GPIO signal (serving as a power-supply control signal of the mobile phone) for powering on the mobile phone at step S140, and transmits the GPIO signal to the mobile phone function module 300 at step S150.

The PDA function module 200 determines at step S160 whether a function for powering off the mobile phone is activated. If it is determined at step S160 that the function for powering off the mobile phone is activated, the PDA function module 300 checks a condition for powering off the mobile phone at step S170, and determines at step S180 whether the condition for powering off the mobile phone is satisfied. For example, where a condition for powering off the mobile phone is indicated as time information, the PDA function module 200 checks a reserved date and time used for terminating a mobile phone function at step S170, and then compares a current time with the checked date and time at step S180.

If it is determined at step S180 that the condition for powering off the mobile phone is satisfied, the PDA function module 200 generates a termination command for powering off the mobile phone at step S190, and transmits the termination command to the mobile phone function module 300 over an IPC task at step S200.

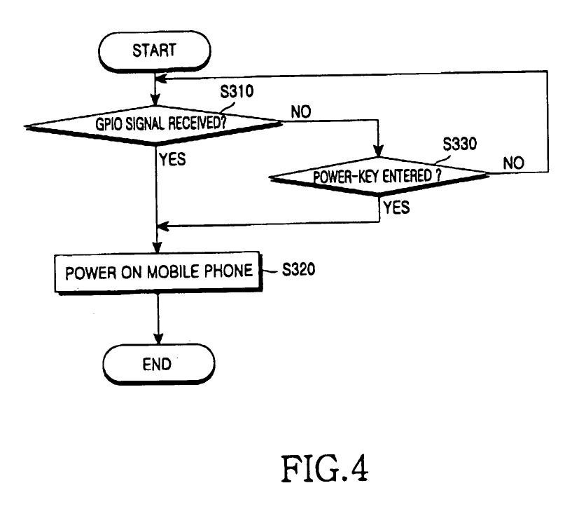

FIG. 4 is a flow chart illustrating a procedure for powering on a mobile phone in a mobile phone control module contained in a hybrid mobile terminal in accordance with a preferred embodiment of the present invention.

A method for powering on a mobile phone in a mobile phone function module 300 of a hybrid mobile terminal in accordance with a preferred embodiment of the present invention will hereinafter be described with reference to FIGS. 2˜4.

Referring to FIGS. 2˜4, the mobile phone function module 300 determines at step S310 whether it receives the GPIO signal created by the above steps 140 and 150 from the PDA function module 200. If the mobile phone function module 300 receives the GPIO signal from the PDA function module 200, then it powers on a mobile phone at step S320 such that a mobile phone function is activated.

Also, even though a power key of the mobile phone (i.e., a power key of a hybrid mobile terminal) is pushed, the mobile phone function module 300 powers on the mobile phone and initiates a mobile phone function. As a result, the mobile phone function module 300 determines at step 330 whether a power key of the mobile phone is pushed even though it does not receive the GPIO signal from the PDA function module 200 at step 310. If it is determined that the power key of the mobile phone is pushed, the mobile phone function module 300 powers on the mobile phone at step S320 such that a mobile phone function is activated. Here, the steps 310 and 330 may be performed in either order.

The following is a procedure that the mobile phone function module 300 powers off the mobile phone in accordance with the embodiment of the present invention.

At step S190, if the termination command is generated, the hybrid mobile terminal transmits the termination command to the mobile phone function module 300 via the IPC task. And then, the mobile phone function module 300 modulates the PS_HOLD (b3) which is a control signal for controlling ON/OFF of the operation of MSM (5100) 330 to be “low” and terminates the operation of the mobile phone function module 300.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A hybrid mobile terminal for performing a PDA (Personal Digital Assistant) function and a mobile phone function, comprising:
a PDA function module for controlling the PDA function, generating a GPIO (General Purpose Input Output) signal for initiating a mobile phone function on the basis of a prescribed condition for initiating the mobile phone function, and generating a termination command for terminating the mobile phone function on the basis of a prescribed condition for terminating the mobile phone function; and
a mobile phone function module for controlling the mobile phone function after being activated upon receiving one of the GPIO signal received from the PDA function module and a power key entry signal of the hybrid mobile terminal.

2. The hybrid mobile terminal as set forth in claim 1, wherein the PDA function module generates the GPIO signal on the basis of a result of comparison between a start time and a current time of the mobile phone function.

3. The hybrid mobile terminal as set forth in claim 1, wherein the PDA function module generates the termination command on the basis of a result of comparison between a termination time and a current time of the mobile phone function.

4. The hybrid mobile terminal as set forth in claim 1, wherein the mobile phone function module includes:
a mobile phone function processor for executing one or more mobile phone functions;
a power-supply controller for applying a power-supply voltage to the mobile phone function processor upon receiving the GPIO signal, and generating a reset signal for initiating the mobile phone function processor; and
a logic gate for transmitting a reset signal to the mobile phone function processor on the basis of at least one of the reset signal generated from the power-supply controller and a power key entry signal of the hybrid mobile terminal.

5. The hybrid mobile terminal as set forth in claim 4, wherein first and second inputs of the logic gate are connected to the reset signal generated from the power-supply controller and the reset signal generated by the power key entry signal of the hybrid mobile terminal, respectively, the output terminal of the logic gate connected to a reset signal input terminal of the mobile phone function processor, wherein the logic gate outputs a reset signal to initiate the mobile phone function processor in the case where one of the reset signal generated from the power-supply controller and the reset signal generated by the power key entry signal satisfies a prescribed condition for resetting the mobile phone function processor.

6. The hybrid mobile terminal as set forth in claim 5, wherein the logic gate is a single AND gate.

7. A method for powering on or off a mobile phone function module of a hybrid mobile terminal comprised of a PDA (Personal Digital Assistant) function module and the mobile phone function module, comprising the steps of:
a) generating a GPIO (General Purpose Input Output) signal for initiating a mobile phone function on the basis of a prescribed condition for initiating the mobile phone function;
b) applying a power-supply voltage to the mobile phone function module upon receiving the GPIO signal, and initializing the mobile phone function module to start the mobile phone function;
c) generating a termination command for terminating the mobile phone function on the basis of a prescribed condition for terminating the mobile phone function; and
d) terminating the operation of the mobile phone function module in accordance with the termination command.

8. The method as set forth in claim 7, wherein step (a) generates the GPIO signal on the basis of a result of comparison between a start time and a current time of the mobile phone function.

9. The method as set forth in claim 7, wherein step (c) generates the termination command on the basis of a result of comparison between a termination time and a current time of the mobile phone function.
